(19) United States
(12) Patent Application Publication
(10) Pub. No.: US 2017/0195363 A1
(43) Pub. Date: Jul. 6, 2017

(54) SYSTEM AND METHOD TO DETECT AND PREVENT PHISHING ATTACKS

(71) Applicant: CHECK POINT SOFTWARE TECHNOLOGIES LTD., TEL AVIV (IL)

(72) Inventors: Meir Jonathan DAHAN, Tel Aviv (IL); Lior DRIHEM, Givat Shmuel (IL); Amnon PERLMUTTER, Givatayim (IL); Ofir TAM, Jerusalem (IL)

(21) Appl. No.: 15/086,085

(22) Filed: Mar. 31, 2016

Related U.S. Application Data
(63) Continuation of application No. 14/985,473, filed on Dec. 31, 2015.

(51) Int. Cl. H04L 29/06

(52) U.S. Cl. CPC H04L 63/1483; H04L 63/1416; H04L 63/06; H04L 63/10

(57) ABSTRACT

Detecting and preventing phishing attacks in real-time features protection of users from feeding sensitive data to phishing sites, educating users for theft awareness, and protecting enterprise credentials. A requested document traversing a gateway is embedded with a detection module. When a user accesses the document, the embedded detection module is executed in the context of the document, checks if the document is prompting the user for sensitive information, determining if the document is part of a phishing attack, and initiates mitigation, warning, and/or education techniques.

### FIELD OF THE INVENTION

The present invention generally relates to data security, and in particular, it concerns preventing phishing attacks.

### BACKGROUND OF THE INVENTION

The escalation of security breaches involving personally identifiable information (PII) has contributed to the loss of millions of records over the past few years. Breaches involving PII are hazardous to both individuals and organizations. Individual harms may include identity theft, embarrassment, or blackmail. Organizational harms may include a loss of public trust, legal liability, or remediation costs [NIST Special Publication 800-122 Guide to Protecting the Confidentiality of Personally Identifiable Information (PII) (April 2010)]

Personally identifiable information (PII), or Sensitive Personal Information (SPI), is information that can be used separately or with other information to identify, contact, or locate a single person, or to identify an individual in context. NIST Special Publication 800-122 Guide to Protecting the Confidentiality of Personally Identifiable Information (PII) (April 2010) defines PII as “any information about an individual maintained by an agency, including (1) any information that can be used to distinguish or trace an individual's identity, such as name, social security number, date and place of birth, mother's maiden name, or biometric records; and (2) any other information that is linked or linkable to an individual, such as medical, educational, financial, and employment information.” So, for example, a user's IP address as used in a communication exchange is classed as PII regardless of whether it may or may not on its own be able to uniquely identify a person.

### SUMMARY

According to the teachings of the present embodiment there is provided a method for identifying a phishing attack including the steps of: embedding a detection module in a document being sent to a user; detecting, by the detection module, the document prompting the user for sensitive information; and determining if the document is part of a phishing attack, wherein the detection module executes in a context of the document, and wherein the determining is at least in part by the detection module.

In an optional embodiment, the document is sent from a server via a gateway to the user on a client. In another optional embodiment, the embedding is performed by the gateway. In another optional embodiment, the embedding is via a technique selected from the group consisting of: enhancing the document, injecting, JavaScript injection, and wrapping. In another optional embodiment, the document is selected from the group consisting of: a web page, downloaded web content, an email message, and an email attachment

In another optional embodiment, the detecting is via a technique selected from the group consisting of: reputation checking, detecting evasion techniques, similarity checking, detecting a deception technique, visual similarity between images embedded in the document and content generated by a trustworthy entity, textual similarity between the document and content generated by a trustworthy entity, visual similarity between one of a web site's URL, a sender's identity, and the document's domain and a trustworthy entity, identifying the use of embedded images instead of text elements, identifying that a URL, domain, or sender with which the document is associated has a low reputation, a URL with which the document is associated uses IP addresses instead of domain names, communication with a server from which the document was received was unencrypted, communication with a server from which the document was received was encrypted using low grade encryption, the document's server presented a certificate that should not be trusted, previous use history of the document's site by other users, and previous use history of the document's site by the user.

In another optional embodiment, the context is selected from the group consisting of: a browser, a browser extension, a secure container application, client applications, a network proxy, and a transparent in line network device.

In another optional embodiment, the method further includes the step of: if the determining is successful, then initiating a technique selected from the group consisting of: disabling one or more elements of the document, disabling posting data to the document's originating site, blocking network traffic to and from the document's originating site, alerting a network administrator, alerting the user, and alerting other uses that have communicated with this phishing site.

According to the teachings of the present embodiment there is provided a system for identifying a phishing attack, the system including: a processing system containing one or more processors, the processing system being configured to: receive a document that has been embedded with a detection module detect the document prompting a user for sensitive information by executing the detection module when the document is accessed; and determine if the document is part of a phishing attack, wherein the detection module executes in a context of the document, and wherein the determining is at least in part by the detection module.

In an optional embodiment, the processing system is a client machine, and the document is sent from a server via a gateway to the user on the client machine. In another optional embodiment, the detection module is embedded by the gateway. In another optional embodiment, the processing system is further configured to: if the document is determined to be part of a phishing attack, then initiating a technique selected from the group consisting of: disabling one or more elements of the document, disabling posting data to the document's originating site, blocking network traffic to and from the document's originating site, alerting a network administrator, alerting the user, and alerting other uses that have communicated with this phishing site.

According to the teachings of the present embodiment there is provided a method for protecting credentials including the steps of: identifying if a site being accessed by a user belongs to a first group of sites; identifying that credentials being entered by the user to the site belong to a first group of credentials; determining if the credentials are being used for access selected from the group consisting of: the site other than in the first group of sites; and the site is other than a second site for which the credentials have previously been used.

In an optional embodiment, the method further includes the step of: if the determining is successful, initiating a technique selected from the group consisting of: disabling one or more elements of a document from the site, disabling one or more elements of a webpage from the site, the site being a website, disabling posting data to the site, blocking network traffic to and from the site, alerting a network administrator alerting the user, alerting other uses that have communicated with this phishing site, and resetting the credentials. In another optional embodiment, the first group of sites are corporate sites. In another optional embodiment, the first group of sites is generated at least in part by monitoring access by other users to sites. In another optional embodiment, the first group of credentials is corporate credentials. In another optional embodiment, the first group of credentials is generated at least in part by monitoring access by the user to sites in the first group of sites. In another optional embodiment, the first group of credentials is a repository of corporate credentials. In another optional embodiment, the method is embedded by a gateway in a document sent from a server via the gateway to the user on a client machine.

According to the teachings of the present embodiment there is provided a system for protecting credentials, the system including: a processing system containing one or more processors, the processing system being configured to: identify if a site being accessed by a user belongs to a first group of sites; identify that credentials being entered by the user to the site belong to a first group of credentials; determine if the credentials are being used for access selected from the group consisting of: the site other than in the first group of sites; and the site is other than a second site for which the credentials have previously been used.

In an optional embodiment, the processing system is further configured to: if the determining is successful, initiating a technique selected from the group consisting of: disabling one or more elements of a document from the site, disabling one or more elements of a webpage from the site, the site being a website, disabling posting data to the site, blocking network traffic to and from the site, alerting a network administrator, alerting the user, and resetting the credentials. In another optional embodiment, the processing system is a client machine. In another optional embodiment, the processing system is configured by a module embedded by a gateway in a document sent from a server via the gateway to the user on the client machine.

According to the teachings of the present embodiment there is provided a non-transitory computer-readable storage medium having embedded thereon computer-readable code for identifying a phishing attack, the computer-readable code including program code for: embedding a detection module in a document being sent to a user; detecting, by the detection module, the document prompting the user for sensitive information; and determining if the document is part of a phishing attack, wherein the detection module executes in a context of the document, and wherein the determining is at least in part by the detection module.

According to the teachings of the present embodiment there is provided a non-transitory computer-readable storage medium having embedded thereon computer-readable code for protecting credentials, the computer-readable code including program code for: identifying if a site being accessed by a user belongs to a first group of sites; identifying that credentials being entered by the user to the site belong to a first group of credentials; determining if the credentials are being used for access selected from the group consisting of: the site other than in the first group of sites; and the site is other than a second site for which the credentials have previously been used.

According to the teachings of the present embodiment there is provided a computer program that can be loaded onto a gateway connected through a network to a client computer, so that the gateway running the computer program constitutes a gateway in a system according to the current description.

According to the teachings of the present embodiment there is provided a computer program that can be loaded onto a computer connected through a network to a gateway, so that the computer running the computer program constitutes a client computer in a system according to the current description.

### BRIEF DESCRIPTION OF FIGURES

The embodiment is herein described, by way of example only, with reference to the accompanying drawings, wherein:

FIG. 1 is a diagram of an exemplary system for detecting and preventing phishing attacks.

FIG. 2 is a diagram of an exemplary system for protecting credentials.

FIG. 3 is a high-level partial block diagram of an exemplary system configured to implement the client or gateway of the present invention.

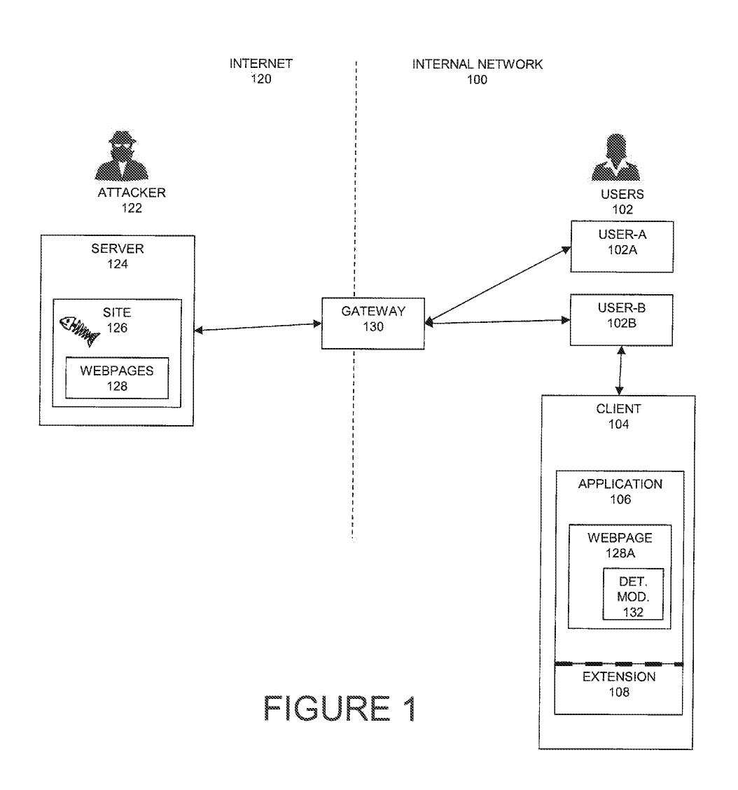

### DETAILED DESCRIPTION—FIRST EMBODIMENT—FIG. 1

The principles and operation of the system according to a present embodiment may be better understood with reference to the drawings and the accompanying description. A present invention is a system and method to detect and prevent phishing attacks. The system facilitates real-time protection of users from feeding sensitive data to phishing sites, educating users for theft awareness, and protecting enterprise credentials.

The term “phishing” is related to deceiving or pretending to be a false entity. A first type of phishing attack (malware infection via an entity that a user knows/trusts) can send a malicious document to an employee in an organization, where the sender pretends to be a fellow co-worker (boss, security, HR personnel). Another example of phishing is an email that lures a victim to enter a harmful site (called a drive-by attack). A second type of phishing is trying to steal information that has value to the attacker by using a false entity. The current embodiment can be applied to both types of phishing, and is particularly useful in preventing this second type of phishing attack.

In the context of this description, the term “phishing” or “phishing attack” is generally used to refer to a kind of electronic crime, an attempted attack, which is aimed at acquiring sensitive information by masquerading as a trustworthy entity. A phishing attack can be aimed at a general audience or can be used to target a specific set of individuals or organizations. A variant of phishing is spear phishing where the adversary is aware and specific about the victim's profile. More than a generic phishing attack, a spear phishing attack can make use of more context information to make users believe that the users are interacting with a legitimate content. For example, a spear phishing email or web page may appear to relate to some specific item of personal importance or a relevant matter at the organization—for example, discussing payroll discrepancies or a legal matter. As in phishing, the ultimate motive is the same—to lure the recipient to an adversary-controlled website faking as a legitimate website and/or collecting sensitive information about the victim or attack the victim's computer. A Phishing attack can use one or more of several vectors including:
Web—a hijacked web site (cross-site scripting) on a legitimate site leading
Mail—with one or more links luring a victim to follow a link
SMS—with a limited “special offer” leading to harmful site
Inside social media websites—false advertisement leading to an attacker page
Mobile Applications—adverts leading to phishing sites
QR code—fake registration posters at legitimate web conferences
Malicious adware—redirecting to fake and identical-looking site upon navigation.

Conventional countermeasures used against phishing are to design anti-phishing filters that can detect text commonly used in phishing emails, recovering hidden text in images, intelligent word recognition—detecting cursive, hand-written, rotated or distorted texts as well as the ability to detect texts on colored backgrounds [draft NIST Special Publication 800-177, Trustworthy Email (September 2015)]

In the context of this description, the term “sensitive information” is generally used to refer to PII, personal/personally identifiable/identifying information and other information of value to an attacker, such as security credentials, social security numbers or ID numbers, credit card information, email addresses, security questions used to authenticate users, and any other sensitive corporate or personal information. Techniques for detecting if sensitive information is being requested (PII detection techniques) include detecting:
The type of form fields being used in the document,
Explicit request for sensitive information,
Detecting that information being input by a user input is (PII) sensitive (for example, in an email message a user inputting a name and credit card number),

Referring now to the drawings, FIG. 1 is a diagram of an exemplary system for detecting and preventing phishing attacks. An external network, such as internet 120 is connected via a gateway 130 to an internal network 100. On the internet 120 an attacker 122 deploys on a server 124 a phishing site 126 optionally having one or more web pages 128. Alternatively, an attacker can hijack a trusted server to deploy or hijack sites and pages on the hijacked server. Users 102 (for example user-a 102A and user-a 102B) are on the internal network 100. Exemplary user-b 102B is working on a client 104 with an application 106. The application 106 optionally has an extension 108 or other related programs and modules. Exemplary served webpage 128A has an embedded detection module 132.

The internet 120 can be any network separate from the internal network 100, including but not limited to the Internet, sub-networks, networks other than the internal network 100, a network other than the network on which the client 104 is deployed, or even another machine on the internal network other than the client machine.

Internal network 100 represents a location on which the users 102 work, on which the users' corresponding machines (client 104) are deployed. Generally, the internal network 100 is the targeted organization's IT infrastructure, and is referred to in the context of this description as the “organization's network” or “network at the organization”. One skilled in the art will realize that for simplicity, the term “internal network” can include a variety of physical implementation and architectures, including but not limited to one or more subnets and additional networks co-located or in physically diverse locations.

For simplicity, the gateway 130 is used to represent a variety of devices, one or more of which can be deployed between the internet 120 and internal network 100, in particular between the attacker 122 (the attack site 126) and the user 102 (the client 104 application 106). In the context of this description, the gateway 130 can represent devices including, but not limited to routers, proxies, proxy servers, servers, firewalls, etc., in general a computing device configured for implementing the appropriate modules of the current embodiment. Alternatively, the gateway can be implemented as a module on the client 104 or in another location on the internet 120 or internal network 100, as is known in the art.

References to the (plural) users 102 may also be in the singular “user”, as appropriate for clarity of the discussion, as will be obvious to one skilled in the art. Users may also be referred to in the context of this description as victims or targets. Similarly, references to the (plural) web pages 128 may also be in the singular “webpage” as appropriate for clarity and simplicity.

The attacker 122 is also referred to in the context of this description as an adversary, an entity trying to implement a phishing attack.

The server 124 may be one or more devices including one or more processors in one or more locations, implemented physically or virtually, as is know in the current state of the art. For simplicity in this description, the server is generally referred to as a web server, serving one or more websites.

The site 126 can be a variety of types of sites providing services to one or more users. For simplicity in this description, the site 126 is generally a website, as is known in the art. The site 126 is generally used in this description as a phishing site, used by the attacker 122 as a phishing document is originating site. A phishing document can be a webpage, or simply referred to as a “page”. Alternatively, an attacker can use one or more sites, with a phishing document originating at a first site and directing users 102 to one or more other sites.

The client 104 is generally a computing device running one or more applications such as the exemplary application 106. For simplicity in this description, the exemplary application 106 is generally a web browser (or simply “browser). Other applications include, but are not limited to email, and SMS.

The application 106 optionally has one or more extensions, such as the extension 108 or other related programs and modules.

As is known in the art, computing devices such as client 104 can be elements such as desktop computers, consoles, laptops, and cell phones referred to as computers, computing devices, and machines.

A method for identifying a phishing attack typically begins with a user, such as the user-b 102B on client 104 requesting a document. A typical case is the user running a web browser application 106 and requesting a webpage 128. In this case, (unbeknownst to the user) the document is a phishing document, specifically webpage 128 coming from a phishing site 126. The document is sent to the user. Typically, the document is sent from the server 124 via gateway 130 to the user on the client 104. When the document traverses the gateway 130, the gateway embeds a detection module in the document. In this case, the exemplary web page 128A is embedded with the detection module 132 and served to the application 106. When the user accesses the document, in the current case viewing the webpage, the embedded detection module checks if the document is prompting the user for sensitive information. If the detection successfully detects that the user is being prompted for sensitive information, then the detection module initiates determining if the document is part of a phishing attack.

A feature of the current embodiment is that the detection module 132 is embedded in the sent document. In other words, the detection module does not require installation, and is preferably not installed on the client 104. The client-side/endpoint does not need to have the detection module, software, or hardware installed to support the current embodiment. The detection module operates (executes) without being pre-installed, and without run-time installation (on the client 104). When the document is accessed, the detection module executes (runs) on the client in the context of the document. For example, when webpage 128A is viewed by browser application 106, the browser is the context in which the detection module is executed. The browser renders the webpage, unpacking and running the webpage—now including the detection module that is also run. Similarly, if the document is an email, when the user reads the email document, the email application is the context, and an extension in the mail client can handle the contents of the email document—including executing, as appropriate, the embedded detection module.

Determining if the document is part of a phishing attack is done at least in part by the embedded detection module as described above and/or as described in the below discussion of detection techniques. Alternatively, the detection module can run on the gateway 130, or the gateway 130 can be the context in which the document is run (for the purpose of detecting a phishing attack before the document is delivered to the client).

As described above, the function of the gateway 130 can be implemented in a variety of locations and modules. Hence, the embedding of the detection module can be done in corresponding locations and modules, as will be obvious to one skilled in the art.

Embedding (the detection module in the document) includes a variety of optional implementation techniques depending on the specific requirements, hardware, operations, and applications. Examples of embedding include, but are not limited to:
Enhancing the document by adding the detection module as additional information,
Injecting the detection module into the document,
Injecting JavaScript into the document, known as JavaScript injection, and
Wrapping the document inside the detection module.

In the context of this description, the term “document” generally refers to a piece of information, generally a file, requested by and/or sent to a user. A typical document is a webpage, such as the exemplary webpage 128A. Other types of documents include, but are not limited to downloaded web content, email messages, and email attachments.

The detection module 132 can analyze the document, optionally and/or additionally monitor the application 106, monitor the client 104, monitor the operation of the document, and monitor user actions.

The detection module 132 implements one or more techniques for detecting if the document is prompting the user for sensitive information, that is, is the document potentially a phishing page (attack). The detection module 132 can be the sole executor of detection techniques, or additionally or alternatively the detection module can work in conjunction with other modules on the client 104, internal network 100, or internet 120 to determine if the document is prompting the user for sensitive information (if the document is a phishing attack). For example, the detection module 132 running on the client 104 can check with a phishing database (not shown in the diagrams) in the internet (cloud). Detection technique may reveal one or more indicators that the document is a phishing attack. Techniques include conventional phishing detection methods and innovative techniques described below. A partial exemplary list of techniques and indicators for detecting a phishing attack and determining if a document is part of a phishing attack include:
Reputations checks:
Identifying that a URL, domain, or sender with which the document is associated has a low reputation,
Offline page asking for sensitive data,
The domain was recently registered,
Domain is not indexed in well-known search engines,
Site referrer is not trusted,
Web site is using a non-standard port,
This web site is using a public IP instead of a DNS name,
A URL with which the document is associated uses IP addresses instead of domain names,
Communication with a server from which the document was received was unencrypted,
The web server is not secured with HTTPS,
Communication with a server from which the document was received was encrypted using low-grade encryption
The document's server presented a certificate that should not be trusted,
The domain is unreasonably long (for example, 130 characters),
The lack of previous use history of the document's site by other users,
The lack of previous use history of the document's site by the user,
Domain contains unreasonable number of words,
Form data is posted to another domain,
Evasions techniques:
This web site is using images only,
Identifying that the entire page is an image,
Identifying the use of embedded images instead of text elements,
Using look alike characters in the title,
Similarity checks:
Re-use of a favicon,
Visual similarity between images embedded in the document and content generated by a trustworthy entity,
Textual similarity between the document and content generated by a trustworthy entity,
Similarity between one of a web site's URL, a sender's identity, and the document's domain and a trustworthy entity,
Title is similar to xxx.com (but not the same),
Web site icon is similar to xxx.com (but not the same),
Quality of web page construction:
Web site has many errors,
Web site has broken links,
Web site does not have a title,
Web site does not have an icon

A document can be classified as a phishing attack based on a function taking in to account the parameter of the indicators, for example, the number of indicators or the relative significance of one or more indicators. Functions include, but are not limited to machine learning techniques, supervised learning, and non-linear functions.

As described above, the detection module is run (executed) in the context of the document. For example, if the document is a webpage, the context can be a browser that renders the webpage for user viewing and executes the detection module. Contexts include, but are not limited to:
Browsers,
Browser extensions,
Email clients (with extension or secure email client),
Secure container applications,
Client applications,
A network proxy, and
A transparent in line network device.

If the determining is successful, that is, if a document is determined to be part of a phishing attack, then mitigation techniques can be used to prevent, mitigate, and/or handle the phishing attack. In a case where the detection module determines that a document is part of a phishing attack, the detection module can implement or initiate mitigation techniques. Alternatively or additionally, the detection module can work in conjunction with other modules on the client 104, internal network 100, or internet 120 to execute or initiate execution of mitigation techniques. Techniques can also be initiated to warn, educate, and/or prevent the user from this phishing attack. Mitigation techniques include, but are not limited to:
Disabling one or more elements of the document (that has been detected as a phishing attack),
Disabling posting data to the document is originating site,
Blocking network traffic to and from the document is originating site,
Initiating an alert,
Alerting a network administrator,
Alerting the user,
Sending a report to a global server, and
Alerting other uses that have communicated with this phishing site.

A feature of the current embodiment is running in real time on the client. As the detection module is downloaded to the user environment, typically as part of the document sent to the client, the detection module runs live on the client concurrent with the received document.

As the detection module runs on the client in the context of the document, the current embodiment avoids potential issues that limit the implementation, operation, and/or effectiveness of conventional techniques. For example, conventional phishing filters on the gateway may not be able to examine a document, as the document may be encrypted or obfuscated. When the document is decrypted and accessed by the corresponding application 106, for example a webpage 128A being rendered by a browser application 106, the actual end page is now accessible at the endpoint (client 104) by the detection module running on the same endpoint (client 104).

The current embodiment can embed the detection module 132 at the gateway 130, thus protecting an entire internal network 100, while being generalized to work with the client-side, in particular running on the client 104 without being installed on the client 104, thus implementing an end-point solution.

The use of embedding (for the detection module), such as JavaScript injection protects a user even without a client.

For storage, the detection module 132 can use local (to the device on which the detection module 132 is running) storage, or remote (other than on the device on which the detection module 132 is running) storage for storing and loading data. For example, remote storage can be another device, server, or gateway 130 on the internet 120 or internal network 100. Examples of data include previously visited sites, icons, text, and password identifiers (hash).

When a document is received from a site, the detection module can, online in real time, rank the site as to a probability that the site is a phishing site. In contrast, conventional ranking of potential phishing sites is normally implemented by sending a remote request to a third party asking the third party to rank the potential phishing site and return a result.

Based on the current description, one skilled in the art will realize that alternative implementations are possible. Alternative implementations include running the detection module as an installed browser agent, browser plug-in, and as an application or module on the client separate from the application receiving the document.

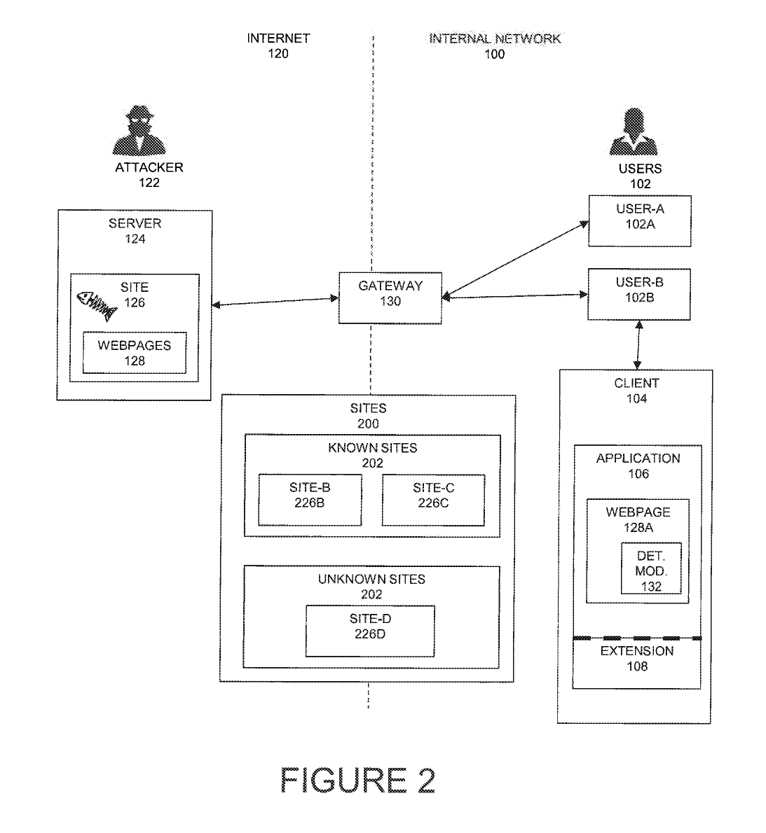

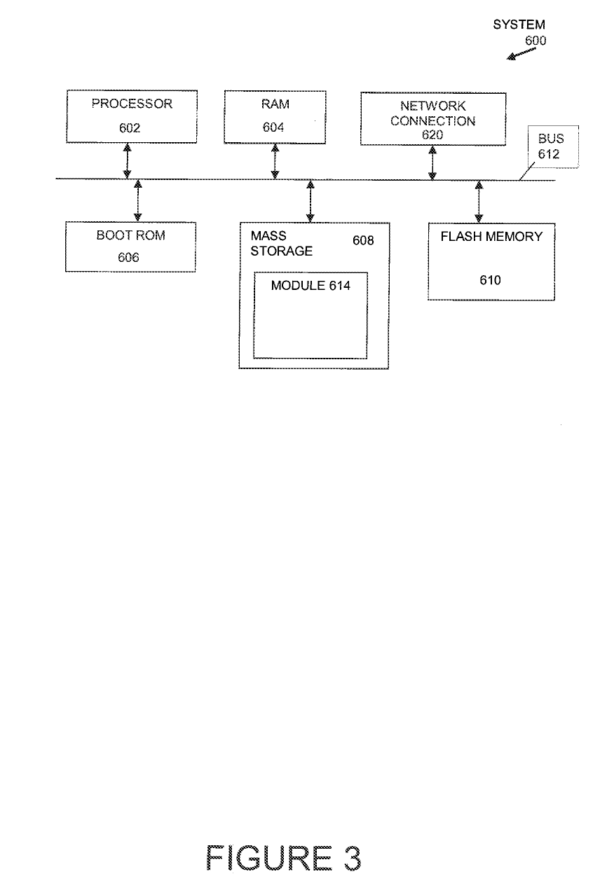

### DETAILED DESCRIPTION—SECOND EMBODIMENT—FIGS. 2 TO 3

When a site of a large external organization (even a trusted site, for example, EBay) is compromised (gets hacked), if passwords used by users on the external compromised site are being re-used by the users for internal (corporate) access, then the compromise of the external site can also compromise the corporate site. Implementations of the current embodiment can increase assurance that corporate assets are protected, even if an external trusted site is compromised. In particular, detecting reuse of a password for multiple sites, or for a site that has not previously been visited by a user (or any user in the corporation) can be an indicator that a site is a phishing site. Note the use of “external” and “internal” sites is for clarity, and based on the current description one skilled in the art will be able to define and implement multiple groups of sites and credentials on the same or different networks.

An innovative method for protecting credentials includes protecting credentials from being used in unauthorized sites, including phishing sites, and protecting against re-use of credentials (credentials being used more than one time for different sites). The method includes identifying if a site being accessed by a user belongs to a first group of sites. The credentials being entered by the user are monitored to identify if the credentials being entered by the user to the site belong to a first group of credentials. If the credentials being entered by the user belong to the first group of credentials, then at least one of two types of access are determined (in other words, if the user is trying to get the following types of access using the credentials):
1) Access to the site, where the site is other than in the first group of sites. In other words, the site is not in the first group of sites. Alternatively, the site can be in a second group of sites, where the second group is other than the first group of sites. In general, this protects credentials from being used in unauthorized sites. In a case where the user is entering corporate credentials, the site that the user is trying to access must be a corporate site (cannot be a non-corporate site).
2) Access to the site, where the site is other than a second site for which the credentials have previously been used. In other words, the user is trying to use credentials that have previously been used for another site to access the site. In general, this protects credentials from being re-used. The second group of sites is not permitted to use the credentials of the first group of sites.

If the determining is successful, in other words if the user is trying to use the credentials in a (possibly or definitely) unsecure manner, then a technique can be initiated to protect the credentials, such as:
Disabling one or more elements of a document from the site,
Disabling one or more elements of a webpage from the site, the site being a website,
Disabling posting data to the site,
Blocking network traffic to and from the site,
Alerting a network administrator,
Alerting the user,
Resetting the credentials.

Referring now to the drawings, FIG. 2 is a diagram of an exemplary system for protecting credentials. A typical case is where a user 102 is working for a company and accessing both corporate and non-corporate sites. Sites 200 can be located on the external internet 120, on the company's internal network 100, or in multiple locations (such as a mix of internet 120 and internal network 100). A group of one or more known sites 202 includes exemplary site-b 226B and site-c 226C. A second group includes one or more unknown sites 202, such as exemplary site-d 226D. Sites 200 may be a variety of sites including websites, ftp sites, etc.

In a non-limiting exemplary case, the sites are websites, the first group of sites is corporate sites, and the first group of credentials is corporate credentials. In this context, the first group/corporate sites are allowed sites, or known sites that the user 102 uses as a part of the user's job. The corporate sites are known sites that are safe to use and the corporation (company) wants to protect from misuse, unsecure practices, compromise, etc.

The first group of sites can be provided as sites that are deployed, run, or maintained by the corporation for normal use by the corporation's employees (users 102). For example, the first group of sites can include the financial database, inventory maintenance website, documentation server, etc. Alternatively or additionally, the first group of sites can be generated at least in part by monitoring access by corporation users 102 to sites. A history of use by the corporation's users indicates which sites 200 are known sites 202. Known sites including corporate sites are then used to create the first group of sites. The first group can include sites based on company policy. If a user visits a site that has not yet been visited by anyone else in the organization, this can be an indicator of a phishing attack (such as trying to compromise the user's credentials). Another indicator of a phishing attack is if a user visits a site that is similar, but not identical, to a site that has been previously visited by the user or other users. In this case, lack of history for a particular site is an indicator that the site is not part of a first group of known, safe sites. An even stronger indicator for a phishing attack is if a user tries to reuse a corporate password in a site that no one in the organization has been to.

Similarly, the first group of credentials is known credentials that legitimately belong to a user and the user uses as part of the user's job. The corporation wants to protect user credentials from misuse, unsecure practices, compromise, phishing attacks, unauthorized disclosure, etc. Credentials are typically information used to login to certain sites, for example usernames and corresponding passwords, but can also be user keys and other credentials as known in the art.

The first group of credentials can be provided as credentials that are deployed or maintained by the corporation for normal use by the corporation's employees (users 102). The first group of credentials can be a repository of corporate credentials. Alternatively or additionally, the first group of credentials can be generated at least in part by monitoring access by corporation users 102 to sites. A history of use by the corporation's users indicates which credentials are used when accessing known sites 202. In particular, generating a first group of credentials for a (specific) user can be done at least in part by monitoring access by the user to sites in the first group of sites. In other words credentials entered by the user on corporate sites.

The user's credentials are monitored and recorded in a history of user credentials. Thus, the credential protection system learns the user's credentials (usernames, passwords, etc.). Elements of the user's credentials can be learned independently, for example, only learning and matching the user's password (and not another element such as the username, at the same time). Some of the recorded credentials will be for the first group of known corporate sites, and some of the credentials will be for a second group of unknown or non-corporate sites. The user's access to sites is monitored. Based on the recorded history of credential use, if a user tries to re-use credentials previously used on a first site to access a second site, this is an indicator of a possible phishing attack or an indicator of poor/unsecure user procedures. Techniques can be initiated to warn, educate, and/or prevent the user from this credential re-use (password re-use).

Using the above-described technique for embedding a module in a document, the current method for protecting credentials can be embedded in a document being sent to a user, for example a login webpage. In this case, the method is embedded by a gateway in a document sent from a server via the gateway to the user on a client machine. Additionally or alternatively, the current method for protecting credentials can be used an indicator of a phishing attack.

A feature of the current method, in particular when implemented using embedding, is that the credential protection is in real time, that is, when a site is accessed and every time a site is accessed the method protects the user's credentials. This can be important in a case where the site is changed after a user's first visit (to maliciously compromise the user's credentials and/or phish for user information), as the site is re-checked when the user re-visits.

The use of history for recording known sites can also be used to record other and related information, for example, keeping a history of URLs, images, page info etc. When a user visits a site, one or more pieces of recorded information can be used to detect if the site is a known site.

Using “crowd knowledge”, that is, historical information gathered from all users in a company (or sub-group), when a single/specific user visits a site, the monitored, recorded, historical crowd knowledge can be used to check if the site is safe (known to the crowd) or a possible phishing attack. A feature of the current method is using knowledge of other users visited sites to detect when a user tries to access a new site that is similar to other users good (safe, known) sites.

The current method for protecting credentials can be used by entities other than corporations. For example, instead of a company's administrator (or user) configuring the first group of sites (known, safe sites) and/or first group of credentials (corporate credentials), a private user can configure a first group of sites (known, safe sites that the user wants to especially monitor or protect) and a first group of credentials (one or more of the user's credentials). For example, a user may want to protect the user's main email account (Gmail) and purchasing site (Amazon), but is not concerned if the user's credentials are compromised on news sites.

The exemplary use of two groups of sites and credentials should not be read as limiting. Based on the above description, one skilled in the art will be able to implement multiple (two, three, or more) groups of sites and credentials, and define which groups of sites are permitted to share which groups of credentials. In a non-limiting example, an administrator defines the following three groups and two rules:
A) Corporate trusted sites (i.e., a corporate financial web service).
B) User trusted sites (i.e., a personal Gmail account).
C) All other sites (i.e., online pizza delivery service and phishing sites).
1) Credentials provided to group A are permitted to be used in accessing sites in-group A.
2) Credentials provided to group A are not allowed to be reused in group B.
3) Credentials provided to group A are not allowed to be reused in group C.
4) Credentials provided to group B are not allowed to be reused to access sites in group C.

FIG. 3 is a high-level partial block diagram of an exemplary system 600 configured to implement the client or gateway of the present invention. System (processing system) 600 includes a processor 602 (one or more) and four exemplary memory devices: a RAM 604, a boot ROM 606, a mass storage device (hard disk) 608, and a flash memory 610, all communicating via a common bus 612. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in processor 602 including but not limited to reduced instruction set computer (RISC) architecture and/or complex instruction set computer (CISC) architecture. A module (processing module) 614 is shown on mass storage 608, but as will be obvious to one skilled in the art, could be located on any of the memory devices.

Mass storage device 608 is a non-limiting example of a non-transitory computer-readable storage medium bearing computer-readable code for implementing the phishing protection methodology described herein. Other examples of such computer-readable storage media include read-only memories such as CDs bearing such code.

System 600 may have an operating system stored on the memory devices, the ROM may include boot code for the system, and the processor may be configured for executing the boot code to load the operating system to RAM 604, executing the operating system to copy computer-readable code to RAM 604 and execute the code.

Network connection 620 provides communications to and from system 600. Typically, a single network connection provides one or more links, including virtual connections, to other devices on local and/or remote networks. Alternatively, system 600 can include more than one network connection (not shown), each network connection providing one or more links to other devices and/or networks.

System 600 can be implemented as a gateway, server, or client respectively connected through a network to a client or server.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

The choices used to assist in the description of this embodiment should not detract from the validity and utility of the invention. It is foreseen that more general choices can be used, depending on the application

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. Note that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A method for protecting credentials comprising the steps of:
(a) identifying if a site being accessed by a user belongs to a first group of sites;
(b) identifying that credentials being entered by the user to said site belong to a first group of credentials;
(c) determining if said credentials are being used for access selected from the group consisting of:
(i) said site other than in said first group of sites; and
(ii) said site is other than a second site for which said credentials have previously been used.

2. The method of claim 1 further comprising the step of: if said determining is successful, initiating a technique selected from the group consisting of:
(a) disabling one or more elements of a document from said site,
(b) disabling one or more elements of a webpage from said site, said site being a website,
(c) disabling posting data to said site,
(d) blocking network traffic to and from said site,
(e) alerting a network administrator,
(f) alerting the user,
(g) alerting other uses that have communicated with this phishing site, and
(h) resetting said credentials.

3. The method of claim 1 wherein said first group of sites are corporate sites.

4. The method of claim 1 wherein said first group of sites is generated at least in part by monitoring access by other users to sites.

5. The method of claim 1 wherein said first group of credentials are corporate credentials.

6. The method of claim 1 wherein said first group of credentials is generated at least in part by monitoring access by the user to sites in said first group of sites.

7. The method of claim 1 wherein said first group of credentials is a repository of corporate credentials.

8. The method of claim 1 wherein the method is embedded by a gateway in a document sent from a server via said gateway to the user on a client machine.

9. A system for protecting credentials, the system comprising: a processing system containing one or more processors, said processing system being configured to:
(a) identify if a site being accessed by a user belongs to a first group of sites;
(b) identify that credentials being entered by the user to said site belong to a first group of credentials;
(c) determine if said credentials are being used for access selected from the group consisting of:
(i) said site other than in said first group of sites; and
(ii) said site is other than a second site for which said credentials have previously been used.

10. The system of claim 9 wherein said processing system is further configured to: if said determining is successful, initiating a technique selected from the group consisting of:
(a) disabling one or more elements of a document from said site,
(b) disabling one or more elements of a webpage from said site, said site being a website,
(c) disabling posting data to said site,
(d) blocking network traffic to and from said site,
(e) alerting a network administrator,
(f) alerting the user, and
(g) resetting said credentials.

11. The system of claim 9 wherein said processing system is a client machine.

12. The system of claim 11 wherein the processing system is configured by a module embedded by a gateway in a document sent from a server via said gateway to the user on said client machine.

13. A non-transitory computer-readable storage medium having embedded thereon computer-readable code for protecting credentials, the computer-readable code comprising program code for:
(a) identifying if a site being accessed by a user belongs to a first group of sites;
(b) identifying that credentials being entered by the user to said site belong to a first group of credentials;
(c) determining if said credentials are being used for access selected from the group consisting of:
(i) said site other than in said first group of sites; and
(ii) said site is other than a second site for which said credentials have previously been used.
